(19) United States
(12) Patent Application Publication
(10) Pub. No.: US 2024/0255460 A1
(43) Pub. Date: Aug. 1, 2024

(54) SENSOR FOR MONITORING INORGANIC SCALES

(71) Applicants: PETRÓLEO BRASILEIRO S.A. - PETROBRAS, Rio de Janerio (BR); INSTITUTO DE TECNOLOGIA E PESQUISA, Aracaju (BR); UNIVERSIDADE TIRADENTES, Aracaju (BR)

(72) Inventors: Arley Alles CRUZ, Aracaju (BR); Giancarlo Richard Salazar BANDA, Aracaju (BR); Elton FRANCESCHI, Aracaju (BR); Gustavo Rodrigues BORGES, Aracaju (BR); Giselle Maria Lopes Leite DA SILVA, Rio de Janerio (BR); Bruno Barbosa CASTRO, Rio de Janerio (BR); Rosane Alves FONTES, Rio de Janerio (BR); Tiago Cavalcante FREITAS, Rio de Janerio (BR); Stefan Suarez FERREIRA, Rio de Janerio (BR); Alexandre Barbosa Melo DE CARVALHO, Rio de Janerio (BR); Felipe Batista ALVIM, Rio de Janerio (BR); Fábio Cleisto Alda DOSSI, Aracaju (BR); Claúdio DARVIA, Aracaju (BR)

(21) Appl. No.: 18/415,071

(22) Filed: Jan. 17, 2024

(30) Foreign Application Priority Data
Jan. 26, 2023 (BR) 1020230014275

(51) Int. Cl. G01N 27/28; E21B 47/00; G01N 27/42

(52) U.S. Cl. CPC G01N 27/286; E21B 47/006; G01N 27/42

(57) ABSTRACT

The present invention relates to the development of equipment capable to monitor the deposition of inorganic compounds in saline solutions in high ion concentration conditions. This invention uses the principle of difference in electrical conductivity that the saline solution and the scale present. In this way, applying the electrical potential to the aqueous solution, through a pair of electrodes, generating an electric current that will be proportional to the conductivity of the compounds present in the medium.

### FIELD OF THE INVENTION

The present invention relates to the development of equipment capable of monitoring the deposition of inorganic compounds in saline solutions under high ion concentration conditions. Such equipment has application in the petrochemical sector, with emphasis on development companies of equipment for research and development, for training studies of inorganic scale in production wells.

### BACKGROUND OF THE INVENTION

Monitoring the formation of scale in the oil sector is of fundamental importance, since this phenomenon is responsible for a series of complications in the most diverse stages of the Hydrocarbons production sector. Such scales can occur on equipment surface and subsurface, contributing to wear and corrosion of these apparatus. In reservoirs, scale is responsible for reducing the porosity and permeability of rock formations, causing a decrease in oil and gas productivity. This is due to the deposit and adherence of these compounds to the pipes, a fact that leads to a gradual decreased fluid flow (Kamal et al., 2018; Olajire, 2015).

Given all these problems inherent to the formation of inorganic scales, many studies focus on understanding the process of scaling, in order to minimize the costs caused by this phenomenon. With technological advances, it is possible to find some experimental techniques to study the scaling process as TBT analysis (from English Dynamic Tube Blocking Test), ultrasound and X or gamma ray radiography. Furthermore, the advent of computers and simulation software has been enabling the construction of mathematical models that attempt to predict the scaling process under the most diverse thermodynamic conditions present in the production field.

However, the most common forms of analysis of the scaling process studied present considerable limitations. For example, in TBT, its use only occurs in laboratory settings to evaluate the process of scaling in flow under different conditions (use of inhibitors, effect of the pressure and temperature variables, etc.), its principle being impractical for detecting scale in the initial stage of formation. According to (Rostron, 2018), in the case of ultrasound techniques there is difficulty in more accurate measurements when pipes have irregular parts or roughness (due to the corrosion process). In emphasis on use of radiographic techniques there is a concern regarding the use of high-intensity radioactive energy that can cause serious risks to field workers (Oliveira et al., 2015). Regarding the use of computational techniques, (Olajire, 2015) highlights that the formation of scaling is a complex process due to a series of existing parameters such as the hydrodynamics of the medium, changes in temperature and pressure conditions, ionic strength, pH and incompatibility between formation and injected waters. Due to these factors, the prediction of scale formation becomes an arduous task and, in some cases, not so efficient.

In this context, a good alternative for analyzing scales is in the measurement of electrical quantities such as potential and electric current. Through these measurements, it is possible to monitor the deposition of scale in electrodes through the significant difference in electrical conductivity (or resistivity) that the solution and the adhered solids possess. With this, it is possible to obtain equipment capable of measuring deposition even with thicknesses in micrometric scale, without the use of radioactive sources and with the application for systems with ion concentrations close to those found in fields of production.

Based on these limitations found in existing equipment and the positive points of using electrical measurements, the proposal arises to developing an equipment based on electrical measurements for the study of the formation of inorganic scale, contributing even more to the study of the formation of inorganic scale.

### SPECIALIZED TECHNICAL LITERATURE

The specialized technical literature discloses some patent documents and scientific articles that use equipment for monitoring the formation of inorganic scale in solutions. This research was carried out with the aim of accentuating the criteria of originality and inventive activity, with searches carried out in the patent database of the Brazilian Patent and Trademark Office (INPI) which has the collection of patents filed in Brazil. In addition of INPI, the European Patent database (Espacenet) was used, which presents the collection of patents filed in more than 90 countries, as well as the use of high standard international scientific articles. What was observed over the long of this research is that no patent documents or scientific article that alludes to monitoring equipment inorganic scale in solutions with solute concentrations close to those found in hydrocarbon production wells were identified.

All documents that were most relevant will be described below, however, it is important to highlight that none of the works break the question of originality of the patent of invention requested in this document.

The article by LIU et al. 2021 evaluates calcium carbonate deposition (CaCO₃) in aqueous solution using a micro crystal balance quartz with dissipation. Through this equipment, the authors were able to monitor the deposition of carbonates, in addition to obtaining mass values deposited and thickness of the salt layer formed. However, the concentration of solute used in this work is lower than the concentration found in the wells of production.

The document PI 0705600-1 A relates to the development of a portable scale detector for pipes using mechanical vibrations in the pipe. However, the analyzes were simulated with pitch inserted into the pipe instead of inorganic scales. This makes the scale layer thickness to be relatively high, which can lead to possible inefficiency of the equipment for detecting scale with lower thickness (such as thicknesses on the micrometer scale).

The document GB 2402738 A relates to a sensor for detecting scaling in oil wells, through the emission of light through optical fiber. However, optical fibers are equipment that presents considerable fragility, and this is equipment that is subject to frequent damage.

The document US 2019293587 A1 relates to a sensor for predicting inorganic scales. However, this equipment has two different settings to detect different types of scaling, making it a more complex and non-generalist device for the most different types of existing scales.

In view of the documents mentioned above, it is possible to conclude that the development of the sensor proposed in this document of patent of invention, entitled: “SENSOR FOR MONITORING INORGANIC SCALES”, has the parameter of originality, as until now, no scientific or technical work comprised in the state of art has similar development technology and applicability. It is also noteworthy that the technology proposed in this document of patent of invention also presents other patentability criteria, such as inventive activity and industrial applicability, requirements necessary for the granting of the requested patent.

### DESCRIPTION OF THE FIGURES

FIG. 1. Schematic diagram of the experimental unit for detection of inorganic scales. (A) reactor, magnetic stirrer, and pair of electrodes, (B) thermostatic bath, (C) electrical potential injection and response current/voltage conversion circuit, (D) symmetrical voltage source, (E) function generator and oscilloscope, (F) computer.

FIG. 2. Schematic diagram of the detection sensor of inorganic scale. (1) Function generator, (2) pair of electrodes, (3) electrical current-potential conversion circuit, (4) symmetrical power supply, (5) oscilloscope.

FIG. 3. Result of the drop in electrical response potential due to the number of batches. At each experimental point, analyzes of scanning electron microscopy (SEM) to check the progressive increased scaling on the electrodes.

FIG. 4. SEM images of electrodes with frontal view during second batch (A) and fourth batch (B) and average measurement of the thickness of the scales.

### SUMMARY OF THE INVENTION

The present invention aims to create equipment for monitoring scale formation in high concentrations of saline solutions. For this, the principle of difference of electrical conductivity that the saline solution and the scale present. In this way, an electrical potential will be applied to the aqueous solution, through a pair of electrodes, generating an electric current that will be proportional to the conductivity of the compounds present in the medium.

The main advantage of this invention is the possibility of identifying the formation of any type of inorganic scale in systems that present high concentrations of salts (as in production waters found in oil wells, for example). This may result in a great technological advance in the scope of research, as such results of equipment can be correlated with physical properties of the scale, such as layer thickness, which may disclose a greater understanding of the process of scale formation. In addition to research, this tool can also contribute to oil fields with insertion of electrodes in the most diverse production stages of hydrocarbons, for real-time monitoring of the deposition of scales. Since this sensor can identify scales with thicknesses on the micrometric scale, this would be essential to warn field operators the presence of these solids, still at an early stage. This would make the scale removal steps more optimized.

### DETAILED DESCRIPTION OF THE INVENTION

In this section all operating and operation details of the “SENSOR FOR MONITORING INORGANIC SCALES”, the objective of which is to describe, in a clear way, how equipment works to detect inorganic scale in saline solutions with high concentrations of ions.

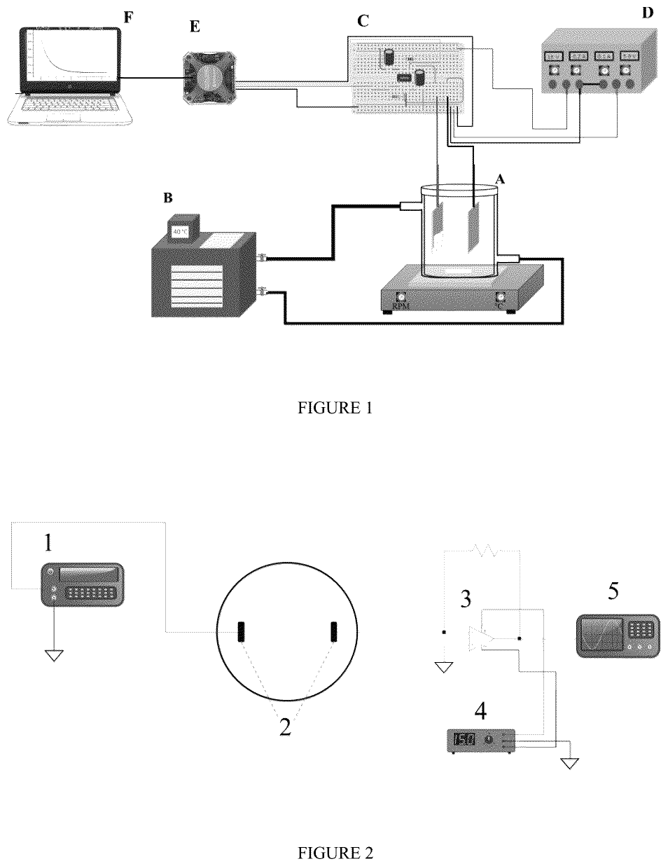

The sensor for monitoring the formation of scale in solutions saline salts at high concentrations, shown in FIG. 2, of the invention here proposed is divided into:
(1) Function generator;
(2) pair of electrodes;
(3) electrical current-potential conversion circuit;
(4) symmetrical power supply; and
(5) oscilloscope.

The function generator (1) is responsible for generating a low amplitude alternating electrical voltage signal as input signal. In this case, a 1 V amplitude signal with 10 Khz frequency and 0 V offset level was used. This signal is sent to the saline solution, kept in a jacketed reactor with temperature control, through one of the electrodes of the pair of electrodes (2) which is immersed in the saline solution. The circuit is closed with a second electrode of the pair of electrodes (2), also immersed in solution, both positioned vertically by means of a pair of rods and which, together with wires, conductors attached to each rod, serve as connectors for electrical conduction between the electronic circuit and the pair of electrodes. This second electrode is connected to the input of the electrical current-potential conversion circuit (3), generating a closure of the circuit through a “virtual ground”. Furthermore, this circuit aims to convert the electrical current that passes through the solution in an electrical voltage value, proportional to the electrical resistance of the saline solution. Thus, the sample is treated as an electrical resistor that has variable resistance. In a first instance, the solution presents a low value of electrical resistance, due to the significant amount of ions present in the solution and the absence of scales on the electrodes.

With the gradual appearance of scales on the surface of electrodes, there is a significant increase in electrical resistance due to insulating characteristic of the scales, preventing the electric current to pass the electrodes. This causes the response signal from the inverter circuit fall as deposits grow on the electrodes. The entire inverter circuit is symmetrically supplied with 15 V via the power supply (4) and the response signals are directly sent to the oscilloscope (5), which has detection of signals up to 15 V. This equipment (5) carries out the acquisition of these signals through an AD converter at a sampling rate of 100 MS/s. This oscilloscope is connected to the output of (3) and the ground cable is connected to the GND of the entire current-voltage conversion circuit (3). The output of (5) is connected to a computer for real-time visualization of signal response, in addition to allowing saving the results for later analysis. It is worth noting that both the function generator (1) and the oscilloscope (5) are inserted into a single piece of equipment, ensuring a more compact sensor.

Tests to guarantee the proper functioning of the sensor in conditions of high concentrations were carried out in batches (represented by FIG. 1) using synthesized water with the same characteristics as an oil well in the Brazilian pre-salt region, wherein the composition and ion concentration can be viewed in Tables 1 and 2.

The entire unit is composed of a jacketed reactor (A) with a total volume of 160 mL, attached to a lid that aims to fix the set of rods for passing signals to the pair of electrodes (stainless steel 316) for checking measurements. The saline solution is inserted into the reactor (A), which features a magnetic stirring system with an adjusted speed of 500 rpm, to promote the precipitation of salts and possible formation of scale. The reactor (A) is temperature controlled through the thermostatic bath (B) which is connected to the jacket of the reactor (A). The electrodes are connected with the electric current-potential conversion circuit (C) and with the function generator (E). The sign of input was adjusted to a frequency of 10 kHz, amplitude of 1 V and 0 V of offset, and this configuration can be changed depending on the application of the equipment. The conversion circuit is fed through the symmetric source (D). The output of the electrical current-potential converter is connected to the oscilloscope (E) that sends response signals to the computer (F) in real time. In this equipment configuration, both the function generator and the oscilloscope are present in the multifunctional equipment (E).

The operating principle occurs with the input of a potential alternating electrical current in a sample that presents a certain electrical resistance. When electrical potential is applied to the analyte, it generates an alternating electrical current that passes through the sample and follows the principle of Ohm's law. This electrical current passes the current-potential conversion that also acts to amplify the output signal (E), according to the value of the resistor used in the operational amplifier. This conversion of current to potential is made for greater ease of measurement by the oscilloscope. When the current passes only through the saline solution, there is a greater flow of current (due to low electrical resistance), reflected in the higher response signal. Throughout the formation of scales on the electrodes, there is greater difficulty in passing the electrical current in the solution (due to the high electrical resistance that scales have), generating a progressive drop in the measured signal.

To verify the functioning of the present invention, a test using water synthesized from a Brazilian oil well was carried out. The test begins with the preparation of synthetic water to detect the scales. This water is divided into anion water and cation water to simulate well injection water and water produced by the reservoir. Once these waters are mixed, there is an incompatibility between them which leads to the formation of scale. All compounds of the two waters, seen in Table 1, were properly weighed on a precision balance and then dissolved in ultrapure water. The volume of each water used in a single batch was 70 mL and the composition of the water can be seen in Table 2.

TABLE 1
Materials used in evaluating the sensor for scale detection
Preparation of synthetic saline solution

| Product | Purity | Manufacturer |
|---|---|---|
| Ultrapure water | — | — |
| Sodium chloride | 99% | Synth |
| Calcium chloride | 99% | Synth |
| Potassium chloride | 99% | Synth |
| Magnesium chloride | 99% | Synth |
| Barium chloride | 99% | Synth |
| Strontium chloride | 99.7% | Synth |
| Sodium bicarbonate | 99.7% | Synth |
| Sodium acetate | 98% | Synth |
| Potassium bromide | 99% | Sigma-Aldrich |
| Sodium sulfate | 99% | Dinamica |

TABLE 2
Composition of the synthetic saline solution
used in the sensor operation tests

| | |
|---|---|
| Salts | Concentration (ppm) |

Cation Solution

| | |
|---|---|
| Na⁺ | 50496 |
| Sr²⁺ | 252 |
| Ba²⁺ | 284 |
| Ca²⁺ | 792 |
| Mg²⁺ | 305 |
| K⁺ | 391 |
| Cl⁻ | 79229 |

Anion Solution

| | |
|---|---|
| HCO₃_{^{−}} | 1544 |
| SO₄_{^{−}} | 46 |
| C₂H₃O₂_{^{−}} | 138 |
| Br⁻ | 0 |

After preparing the water, both were placed inside the reactor (A) and the pair of electrodes was immersed into the solution to detect the scales. The measurement was carried out at the initial moment of the immersion and these data were collected and sent to an excel spreadsheet for later assembly of the signal response graph. After collecting the results for the first batch, the pair of electrodes was completely submerged to the bottom of the reactor (A), where it remained for a period of 2 hours so that there was greater accumulation of scale. Immediately afterwards, the electrodes were removed from the reactor (A) and placed in an oven at 90° C. for 12 hours for greater adhesion of solids to the pair of electrodes. After the drying stage, the electrodes were taken to the scanning electron microscopy (SEM) to assess the coverage and distribution of scales on the electrodes. With the end of the analyzes via SEM, the same encrusted electrodes, were taken to the next batch to observe the presence of scale from the previous batch. This process was done by 4 times and aims to accumulate, with each batch, a greater quantity of scales on the electrodes.

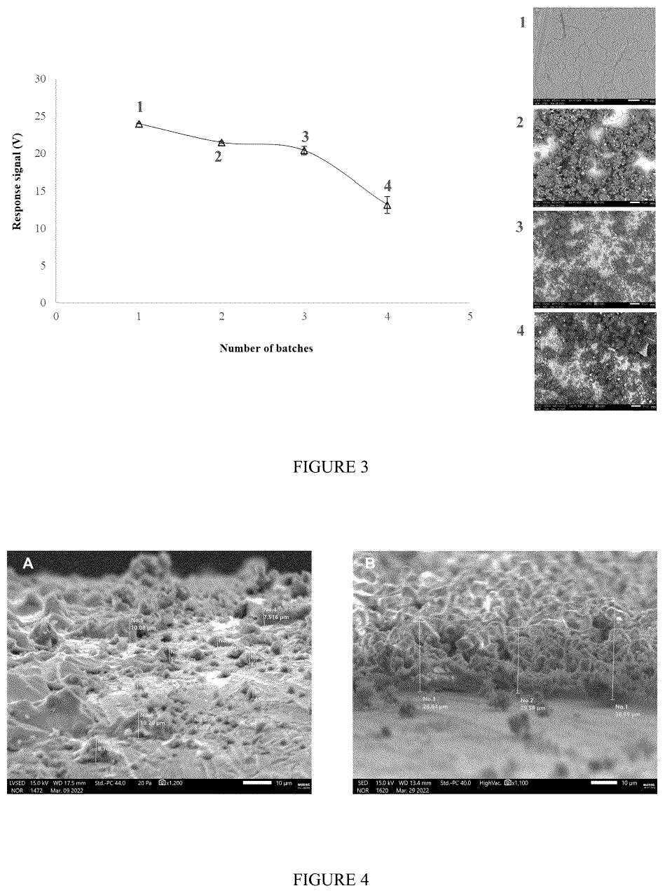

Finally, the results of the response signal for each batch were placed on a graph (FIG. 3) to analyze the results. It is possible to observe a drop in the response signal throughout the batches, showing the increasing accumulation of scale on the electrode. This is confirmed through the SEM analysis that revealed the successive increase in the inorganic deposit area on the electrodes. More detailed images of a small fraction of the electrode also reveal the way in which different materials deposited are distributed throughout the batches, with the main deposits being calcium carbonate and barium sulfate. In FIG. 4 it is also observed a relationship between the thickness of the scale and the results of the sensor developed, wherein the image on the left refers to the second batch and reveals an average thickness of 8.6±2.5 μm. With the increase in number of batches, it was possible to observe the formation of a layer of more uniform scale with a greater thickness (29.6±5.5 μm) such a process being detected by the present equipment developed. The tests were carried out in duplicate, also showing the reproducibility of the equipment for monitoring scale.

1. SENSOR FOR MONITORING INORGANIC SCALE, characterized by being a compact equipment for monitoring the deposition of inorganic compounds in saline solutions under high ion concentration conditions composed of: (1) function generator; (2) pair of electrodes; (3) electrical current-potential conversion circuit; (4) symmetrical power supply; and (5) oscilloscope.

2. SENSOR FOR MONITORING INORGANIC SCALE, according to claim 1, characterized in that the function generator (1) generates a low alternating electrical voltage amplitude as input signal, using a 1 V amplitude signal with 10 Khz frequency and 0 V offset level, this signal is sent for the saline solution, maintained in a jacketed reactor with controlled temperature, through a conductor wire, connecting the generator output of functions to one of the electrodes of the electrode pair (2) that is immersed in saline solution, then the circuit is closed with a second electrode of the electrode pair (2), also immersed in solution, which is directly connected to another conductor wire.

3. SENSOR FOR SCALE MONITORING INORGANIC, according to claims 1 and 2, characterized in that the conductor wire is connected to the input of the electrical current-potential conversion circuit (3) generates a closure of the circuit through of a “virtual ground”, converting the electrical current that passes through the solution in an electrical voltage value, proportional to the resistance electricity from the saline solution.

4. SENSOR FOR MONITORING INORGANIC SCALE, according to claim 1, characterized in that the inverter circuit is symmetrically fed with 15 V through the power supply (4) and response signals are directly sent to the oscilloscope (5) which is connected to a computer for real-time visualization of response signals.

5. SENSOR, according to claims 1 and 4, characterized by coupling the electronic circuit (3) developed with the oscilloscope (5) with analog-to-digital conversion equal to or greater than 100 MS/s and maximum detection amplitude above 15 V with the probe connected to the circuit output and the grounding cable connected to the GND of the entire current-voltage circuit for signal measurements.

6. SENSOR, according to claim 1, 2, 3, 4 or 5, characterized in that the electronic part of the sensor connects the two electrodes (3), of any conductive material and with high resistivity to corrosion, in rods for vertical fixation for immersion in saline solutions and electrical conduction between the electronic circuit and the emerged electrodes, the first electrode must be connected directly to the output of the function generator (1), while the second electrode must be connected to the input inverting the operational amplifier, the connections of these rods with the circuit and function generator must be carried out by means of electrical cables.

7. MONITORING INORGANIC SCALES, according to claim 1, characterized in that the detection of inorganic scales consists of a (A) reactor, magnetic stirrer and pair of electrodes, (B) thermostatic bath, (C) electrical potential injection circuit and response current/voltage conversion, (D) symmetric voltage source, (E) function generator and oscilloscope, (F) computer.

8. MONITORING INORGANIC SCALES, according to claim 1, characterized by inserting saline solution into the reactor (A), which features a magnetic stirring system with an adjusted speed of 500 rpm, to promote the precipitation of salts and possible formation of scale, with the temperature controlled by means of the thermostatic bath (B) which is connected to the jacketed reactor (A), the electrodes are connected to the electrical current-potential conversion circuit (C) and with the function generator (E), the input signal was adjusted to a frequency of 10 kHz, 1 V amplitude and 0 V offset, the conversion circuit is powered through the symmetrical source (D), the output of the electrical current-potential converter is connected to the oscilloscope (E) which sends to the computer (F) real-time response signals, both the function generator and the oscilloscope are present in the multifunctional equipment (E).

9. MONITORING INORGANIC SCALES, according to claim 1, characterized in that the operation is through the input of an alternating electrical potential into a sample which presents a certain electrical resistance, this electrical current passes through current-potential conversion, which also acts on the amplification of the output signal (E), according to the value of the resistor used in the operational amplifier.
